(19) United States
(12) Patent Application Publication
(10) Pub. No.: US 2010/0064012 A1
(43) Pub. Date: Mar. 11, 2010

(54) METHOD, SYSTEM AND APPARATUS TO AUTOMATICALLY ADD SENDERS OF EMAIL TO A CONTACT LIST

(75) Inventor: Charles Cruse, JR., Cary, NC (US)

Correspondence Address: CARPENTER & ASSOCIATES, 5 PIPESTEM COURT, ROCKVILLE, MD, 20854, US

(73) Assignee: International Business Machines Corporation, Armonk, NY (US)

(21) Appl. No.: 12/206,711

(22) Filed: Sep. 8, 2008

(51) Int. Cl. G06F 17/00

(52) U.S. Cl. 709/206

(57) ABSTRACT

A method for adding senders of email to a contact list, including: a user creating and storing a contact list in an email system; the user entering a rule into the email system defining when a sender of an email that is received by the user will be added to the contact list automatically by the email system based on text in the sender's email matching text required by the rule; the user receiving emails from a plurality of senders, some of the emails having the matching text required by the rule and others of the emails not having the matching text required by the rule; the email system automatically adding to the contact list only any of the plurality of senders that sent emails having the matching text required by the rule and that are not already included on the contact list.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### THE NAMES OF THE PARTY TO A JOINT RESEARCH AGREEMENT

(Not Applicable)

### INCORPORATION-BY-REFERENCE OF MATERIAL SUBMITTED ON A COMPACT DISC

(Not Applicable)

### BACKGROUND OF THE INVENTION

(1) Field of the Invention

This disclosure is directed to methods, systems and apparatus that automatically add senders of email to a contact list.

(2) Description of Related Art Including Information Submitted Under 37 CFR 1.97 and 1.98

As more and more people utilize Email to communicate. Email address books can become very large.

### BRIEF SUMMARY OF THE INVENTION

At least some aspects of this disclosure are directed to methods, systems and apparatus to automatically add senders of email to a contact list.

In particular, at least some aspects of this disclosure are directed to a method for adding senders of email to a contact lists including: a user creating and storing a contact list in an email system; the user entering a rule into the email system defining when a sender of an email that is received by the user will be added to the contact list automatically by the email system based on text in the sender's email matching text required by the rule; the user receiving emails from a plurality of senders, some of the emails having the matching text required by the rule and others of the emails not having the matching text required by the rule; the email system automatically adding to the contact list only any of the plurality of senders that sent emails having the matching text required by the rule and that are not already included on the contact list.

Also, at least some aspects of this disclosure are directed to a system and/or apparatus for adding senders of email to a contact list, including: a contact list stored in an email system; a rule in the email system that defines when a sender of an email that is received by the user will be added to the contact list automatically by the email system based on text in the sender's email matching text required by the rule; and when a user receives emails from a plurality of senders, some of the emails having the matching text required by the rule and others of the emails not having the matching text required by the rule, the email system automatically adds to the contact list only any of the plurality of senders that sent emails having the matching text required by the rule and that are not already included on the contact list.

Other aspects of this disclosure are directed to a computer program for executing the methods and/or systems of this disclosure. Still other aspects of this disclosure are directed to a storage medium that stores a computer program for executing the methods and/or systems of this disclosure. Yet other aspects of this disclosure are directed to a computer apparatus that is running a computer program and that is executing the methods and/or systems of this disclosure.

Other exemplary embodiments and advantages of this disclosure can be ascertained by reviewing the present disclosure and the accompanying drawings.

### BRIEF DESCRIPTION OF THE SEVERAL VIEWS OF THE DRAWING(S)

This disclosure is further described in the detailed description that follows, with reference to the drawings, in which:

FIG. 1 illustrates a computer monitor screen showing a graphic user interface in accordance with at least some aspects of this disclosure;

FIG. 2 illustrates a computer monitor screen showing a graphic user interface in accordance with at least some aspects of this disclosure; and

FIG. 3 illustrates a computer monitor screen showing a graphic user interface in accordance with at least some aspects of this disclosure.

### DETAILED DESCRIPTION OF THE INVENTION

Exemplary embodiments of this disclosure are described herein by way of example.

Current email systems provide ways to add contacts to an address book directly from a sender's email. For example, a user can select many emails and have all the senders of those emails added as contacts in the address book all at one time.

Those same systems can also provide a way within the address book to define a contact list (group) containing many contacts. From the address book, a user can select many contacts and have all of those contacts added to the same contact list.

However, as more and more people utilize email, address books can become very large and difficult to manage. When attempting to construct a contact list for a large number of people, users can struggle through the large address book to select all of their desired contacts in order to add them to the contact list or the users can manually enter the contact names. Even simply adding the contacts from the emails can be very tedious, very time consuming, and can lead to the error of omitting one or more of the intended contacts from the list.

One method to improve this can be to allow an email user to select a number of emails and have the senders of the emails added to a designated contact list. However, even with such a methods the user has to pick and choose each contact to add to the contact list.

The email system currently allows the user to establish a rule that directs the email system to take certain actions (delete, move to folder, etc.) based on characteristics (subject, sender, etc.) of an incoming email.

This disclosure provides a method, system and apparatus that can enhance the email system by adding the capability of establishing and implementing a rule that can allow a user to designate an action of adding a sender to a contact list. In such a manner, the user can automatically build the contact list as particular emails are received.

This invention can save much time and frustration when creating contact lists (groups). For administrative assistants and others organizing large contact lists, this can be especially beneficial.

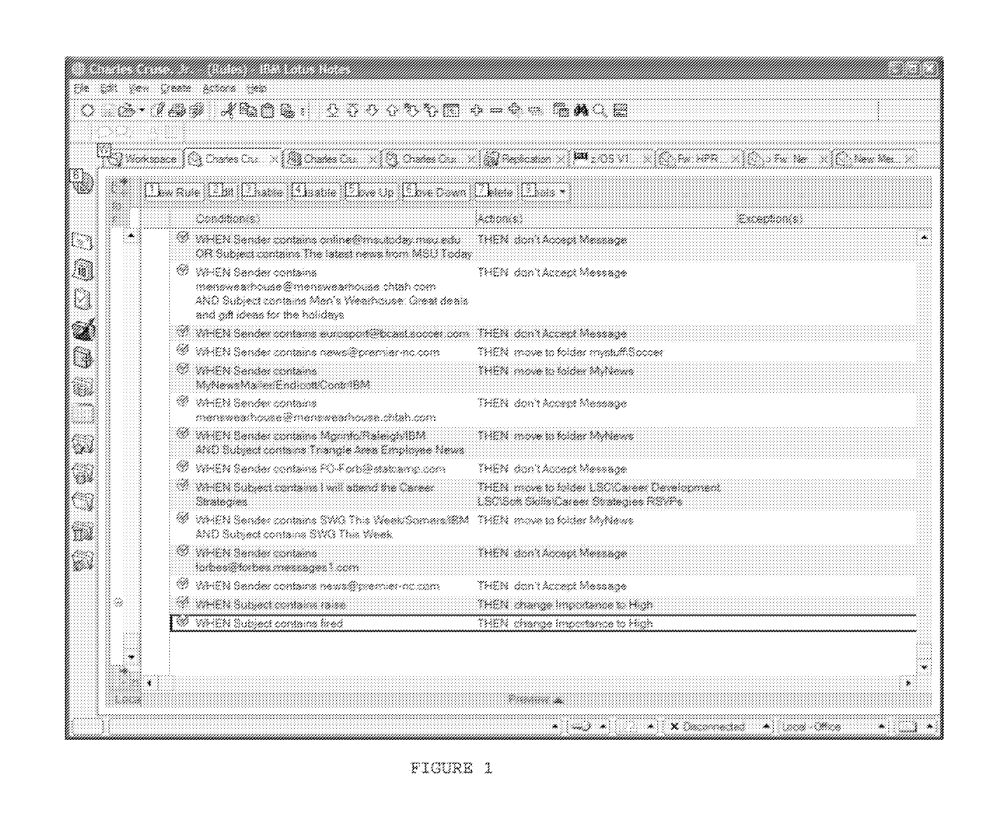

Some email systems currently allow a user to establish various rules for how to handle certain incoming email. FIG. 1 shows a window including several exemplary rules that one user has established.

The rules shown have various actions (e.g., “don't accept message,” “move to folder Probable Spam,” etc.).

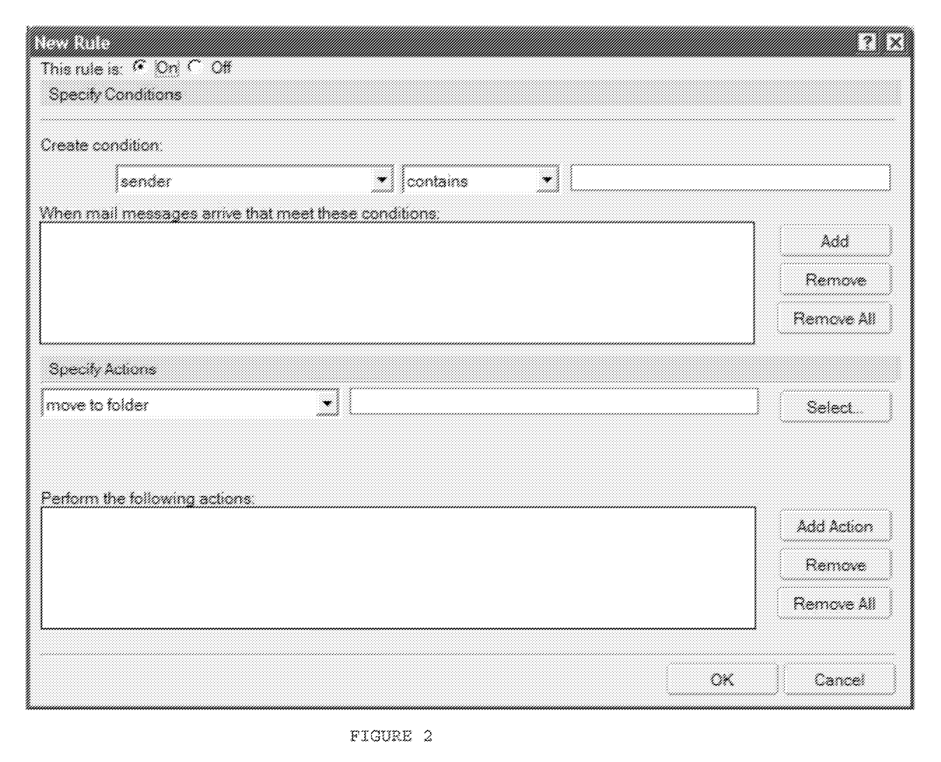

A new rule can be added by clicking the New Rule button, which opens the window shown in FIG. 2.

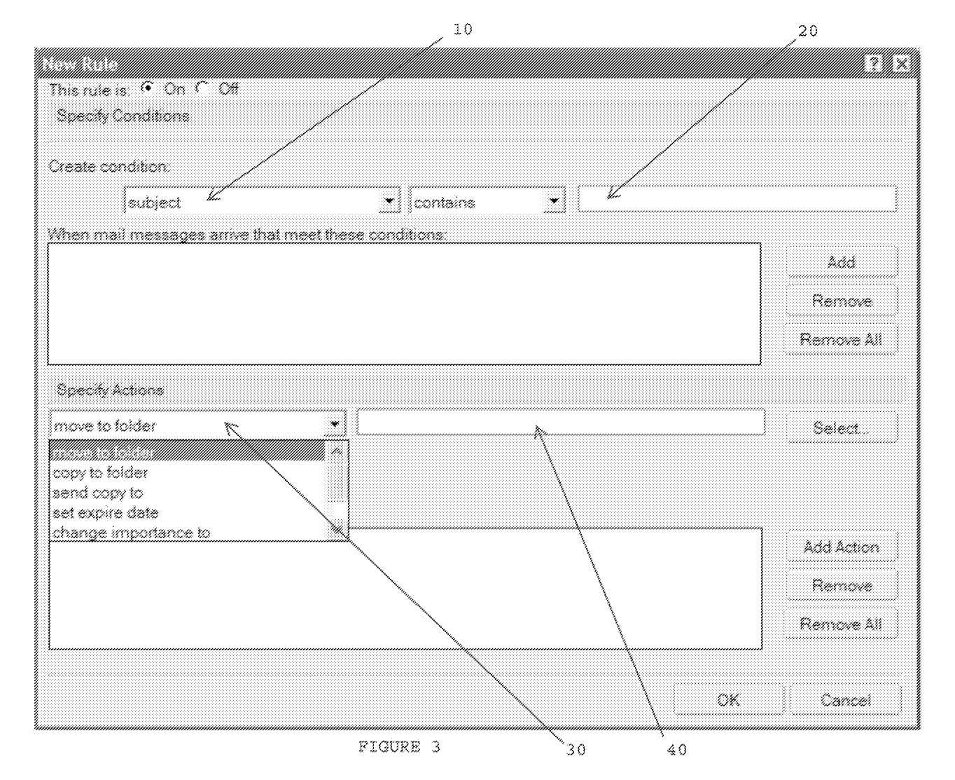

There are several actions that can be specified for the new rule, as shown in FIG. 3.

This disclosure provides a method and system (and apparatus for executing the method and system) for providing and utilizing an Action referred to as “add sender to contact list” and allowing a user to specify the name of a contact list to which the sender should be added when email is received by the user that matches a condition specified by the user.

Thereafter, when email is received by the user that matches the specified condition, the sender of the email will automatically be added to the designated contact list.

This method of having the email system automatically construct the contact list as email is being received by the user is distinct from the concept of allowing the email user to manually construct a contact list from emails previously received.

As an example of what can be done with this enhancement, after a user defines a contact list named for example, DisneyTripList, the user can define a rule that says “WHEN Subject contains Count me in for the Disney Trip THEN add sender to contact list DisneyTripList.”

Thus, for this example, with reference to FIG. 3, box 10 can be changed to “subject” and “Count me in for the Disney Trip” can be entered into box 20 by the user.

The user can change box 30 to “add sender to contact list,” a new selection added by this disclosure, and “DisneyTripList” can be entered into box 40 by the user.

Thereafter, whenever an email is received by the user where the subject says, “Count me in for the Disney Trip”, in this example, the email system will automatically add the sender to the DisneyTripList contact list.

The automatic building of the contact list can aid, for example, administrative assistants and other organizers of large activities having an email contact list by saving these individuals time and reducing the likelihood of human error in constructing contact lists.

This disclosure is directed to a method and system for building a contact list that can be achieved automatically by allowing the user to establish a rule in the email system.

The foregoing exemplary embodiments have been provided for the purpose of explanation and are in no way to be construed as limiting this disclosure. This disclosure is not limited to the particulars disclosed herein but extends to all embodiments within the scope of the appended claims, and any equivalents thereof.

1. A method for adding senders of email to a contact list, comprising:
a user creating and storing a contact list in an email system;
the user entering a rule into the email system defining when a sender of an email that is received by the user will be added to the contact list automatically by the email system based on text in the sender's email matching text required by the rule;
the user receiving emails from a plurality of senders, some of the emails having the matching text required by the rule and others of the emails not having the matching text required by the rule;
the email system automatically adding to the contact list only any of the plurality of senders that sent emails having the matching text required by the rule and that are not already included on the contact list.
